(19) United States
(12) Patent Application Publication
(10) Pub. No.: US 2009/0037411 A1
(43) Pub. Date: Feb. 5, 2009

(54) Membership selection assistant

(76) Inventors: Vaibhava Goel, Elmsford, NY (US); Sumedha Gupta, Elmsford, NY (US)

Correspondence Address: VAIBHAVA GOEL, 67 NOB HILL DRIVE, ELMSFORD, NY, 10523, US

(21) Appl. No.: 11/888,050

(22) Filed: Jul. 31, 2007

(51) Int. Cl. G06F 17/30

(52) U.S. Cl. 707/5; 707/E17.108

(57) ABSTRACT

A method and apparatus for a membership selection assistant that assists users in selecting a set of memberships to carry out a set of actions. This assistance is provided by determining what actions the user wishes to carry out and what memberships the user wishes to consider for those actions; then determining what benefits the user would derive by use of the memberships they have identified; then consolidating and rank ordering the benefit information; then either presenting the user with consolidated and rank ordered information, or automatically making optimal membership selection.

### FIELD OF THE INVENTION

The present invention generally relates to membership programs and more particularly to a method and apparatus for selection of one or more memberships to use for a set of actions.

### BACKGROUND OF THE INVENTION

Individuals and entities such as organizations are often affiliated with membership programs such as credit cards like Citibank Platinum MasterCard, Discover Card, etc., associations like American Automobile Association, Sam's Club, Costco, Diners Club, gymnasium memberships, student identification cards, etc. These membership affiliations are primarily used to facilitate users (individuals and entities) to carry out their desired actions. For example, individuals and organizations often use credit cards to carry out their financial transactions that allow use of a credit card.

Often times, users run into situations where their desired actions can be carried out by using any one (or more) of a number of memberships that they are affiliated with. Users then have to select a set of memberships that they wish to use to carry out their desired actions.

To bias users toward selecting their membership, the membership programs often have benefit (or reward) programs that give users rewards for using their membership. The type and extent of reward varies depending on the user action. Some examples of these benefits are: cash back as a percent of purchase amount, points in some points program which can later be used as a discount on some purchase or used to get cash back, miles in frequent flyer programs, insurance for automobile rental, low annual percent rate for borrowing money, etc.

However, due to the number of, and sometimes dynamic nature of the benefits program, users find it difficult to keep track of these benefits. In fact, many users are not even aware of the benefits available to them. In the absence of any guidance on which membership to use, users end up missing out on a lot of benefits they may have obtained.

Examples of prior art on making membership cards physically attractive to bias users include U.S. Pat. Nos. 6,325,284 and 5,746,451. However, these methods only focus on the look and feel of the cards and do not take into account the benefits obtained from use of memberships.

U.S. Pat. Nos. 5,585,787 and 7,072,864 describe programmable multi-value cards wherein a single card carries multiple credit card accounts and allows user to choose which account the user wishes to use. However, the selection is entirely up to the user and no assistance, based on benefits or otherwise, is provided toward selection.

U.S. Pat. No. 7,234,638 describes a method and apparatus for performing benefit transactions using electronics embedded on portable devices such as a smart card. However, in this method again the selection of membership is left entirely up to the user and no assistance, based on benefits or otherwise, is provided toward selection.

Example prior art on presenting benefit information for memberships include internet sites http://www.e-wisdom.com/credit_cards/index.html and http://Get-Credit.net. However, these websites list only a few important benefits of a number of memberships with the intent of allowing users to compare memberships. These websites do not associate those benefits with user actions, nor do they perform any customization using user specific data. Furthermore, these websites are almost exclusively focus on credit cards and do not take other memberships into consideration.

### BRIEF SUMMARY OF THE INVENTION

In view of the foregoing and other exemplary problems, drawbacks, and disadvantages of the conventional methods and structures, the present invention is of method and apparatus for a membership selection assistant that assists users in selecting a set of memberships that they could use to carry out a set of actions. This assistance is provided by determining what actions the user wishes to carry out and what memberships the user wishes to consider for those actions, and then either presenting the user with information on benefits that they would derive by using those memberships for those actions or automatically making optimal membership selection.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates a system 100 in accordance with an exemplary embodiment of the present invention; and

FIG. 2 illustrates a system 200 in accordance with another exemplary embodiment of the present invention, including user preferences and data; and

FIG. 3 illustrates a system 300 in accordance with another exemplary embodiment of the present invention, including user identification; and

FIG. 4 illustrates a system 400 in accordance with another exemplary embodiment of the present invention based on a distributed configuration of system components; and

FIG. 5 illustrates an exemplary embodiment of the membership database record 500; and

FIG. 6 illustrates a system 600 in accordance with another exemplary embodiment of the present invention, based on a distributed configuration and a hand-held device; and

FIG. 7 illustrates exemplary embodiments of the membership set identification module 703, the action set identification module 704, and the presentation and selection module 705; and

FIG. 8 illustrates an exemplary embodiment of the user preference and data interface 809; and

FIG. 9 illustrates an exemplary embodiment of the search module; and

FIG. 10 illustrates another exemplary embodiment of the search module, utilizing an alternative search algorithm; and

FIG. 11 illustrates a method 1100 in accordance with an exemplary embodiment of the present invention; and

FIG. 12 illustrates a method 1200 in accordance with another exemplary embodiment of the present invention, including user preferences, user data, and user identification.

### DETAILED DESCRIPTION OF EXEMPLARY EMBODIMENTS OF THE INVENTION

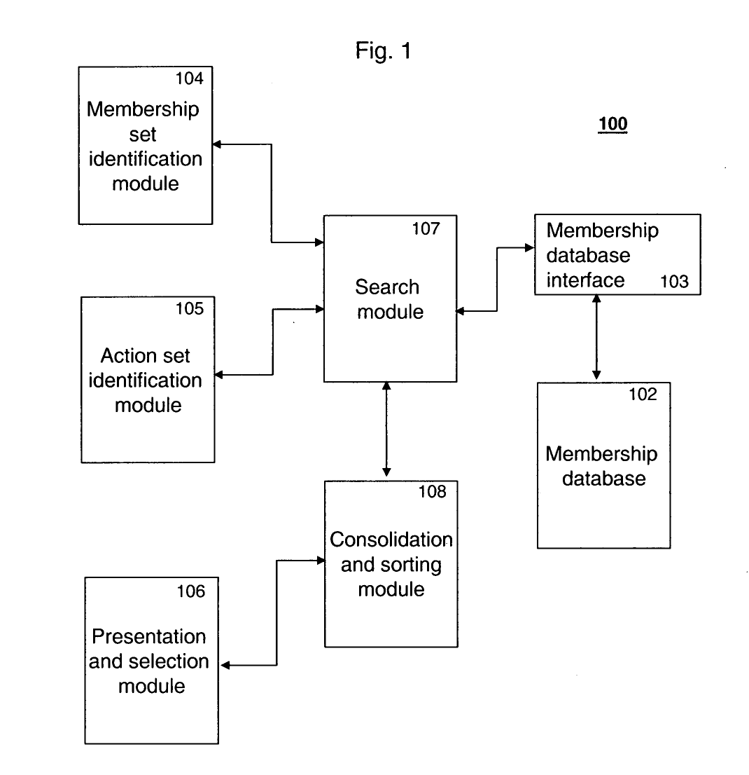

Referring to FIG. 1 which depicts a system 100 according to an exemplary embodiment present invention, the action set identification module 105 allows specification of the user's desired set of actions for which the user wishes to select memberships to use.

The membership set identification module 104 allows specification of a list of memberships that the user wishes to choose from, for user's desired set of actions.

The membership database 102 contains information on memberships and benefits associated with those memberships for various actions. This database is accessed using the membership database interface 103.

The search module 107 carries out a search on the membership database 102 to retrieve a set of membership database records that are relevant for the specified memberships and actions.

The database records retrieved by the search module 107 are passed on to the consolidation and sorting module 108. This module performs two functions: a) It evaluates permitted combinations of membership database records to determine benefits that would be achieved by consolidations across various memberships and/or actions, and b) It provides an ordering of original and consolidated records. The consolidation and order information, along with any auxiliary information needed for membership selection, is sent to the presentation and selection module 106.

The presentation and selection module 106 receives the sorted records and other auxiliary information from the consolidation and sorting module 108, and uses that to facilitate the user in making the selection of memberships to use.

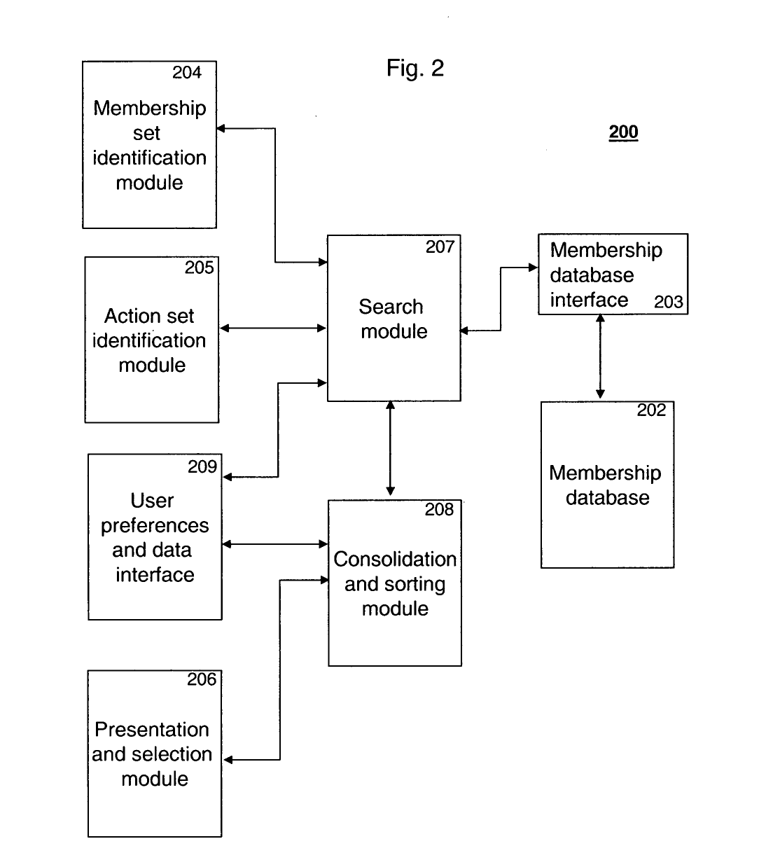

FIG. 2 depicts a system 200 according to another exemplary embodiment of the present invention. In this exemplary embodiment, as an additional feature over the embodiment of FIG. 1, users provide their preferences and data that are used to customize the invention components. For instance, the database search carried out by the search module 207 is guided by user preferences, and the consolidation and sorting module 208 uses user data and user preferences to carry out its operations. User provides data and preferences using the user preference and data interface 209.

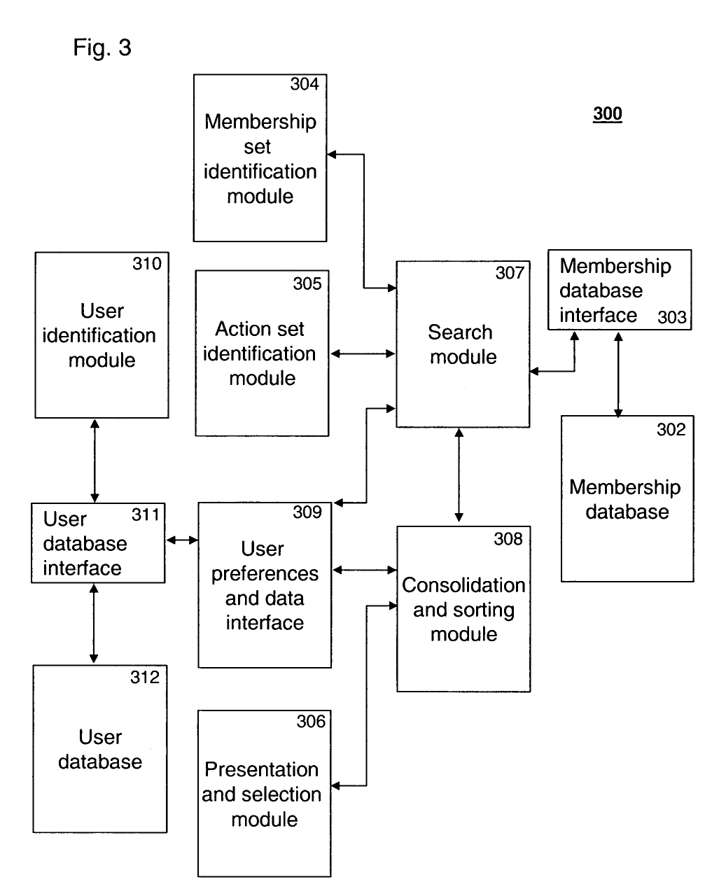

FIG. 3 depicts a system 300 according to another exemplary embodiment of the present invention. This embodiment includes storage of user preferences and data, including the membership information provided by the user, so that users do not have to specify those every time they wish to use the membership selection assistant. An identification of the user, to the extent possible, is be carried out by the user identification module 310. User preferences and data are stored in a user database 312, associated with the user identity information provided by the user identification module. User database is accessed using the user database interface 311.

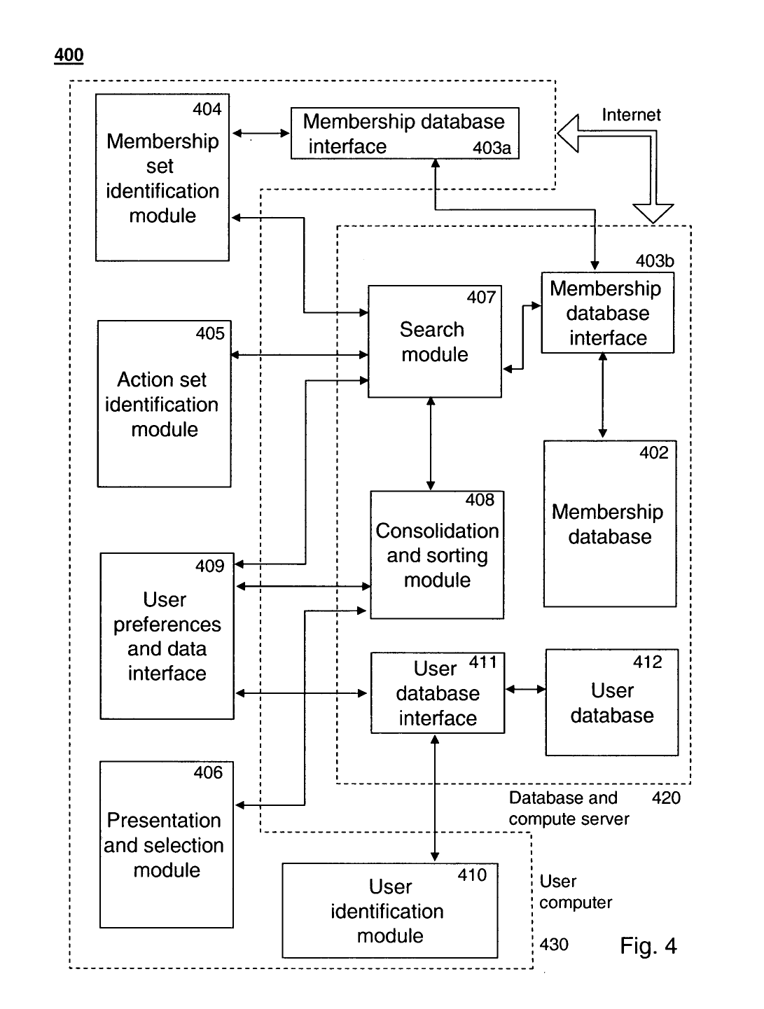

A system 400 according to an exemplary embodiment of the present invention is based on a distributed configuration where components of the invention reside on multiple computers connected to each other via the internet, as shown in FIG. 4. In the configuration shown in FIG. 4, there are two computers: a user computer 430 that the user has access to, and a computer labeled database and compute server 420 managed by an administrator. FIG. 4 also shows which component of the invention resides on which machine.

As shown in the exemplary embodiment of FIG. 4, the membership set identification module 404, the action set identification module 405, the presentation and selection module 406, the user preferences and data interface 409, and the user identification module 410, all reside on the user computer 430. The membership database interface is distributed—one part 403a resides on the user computer 430 and a second part 403b resides on the database and compute server 420. The membership database 402, the search module 407, the consolidation and sorting module 408, the user database 412, and the user database interface 411 all reside on the database and compute server 420.

Referring to FIG. 4, in an exemplary embodiment, the membership database 402 contains records for a number of memberships. These records are not specific to any particular user, except if particular fields make them specific to a user. These records are entered into the database using the membership database interface 403a or 403b. Additionally, users can provide membership database records to account for cases, for example, when the user's desired membership or action are not found in the membership database. When the user enters the membership records into the database, those records are kept specific to that user. At the time of entry of these records into the database, the user is given the option of making these records available all users. If the user so chooses, those records will be sent to the administrator of database to be reviewed and entered into the database for all users.

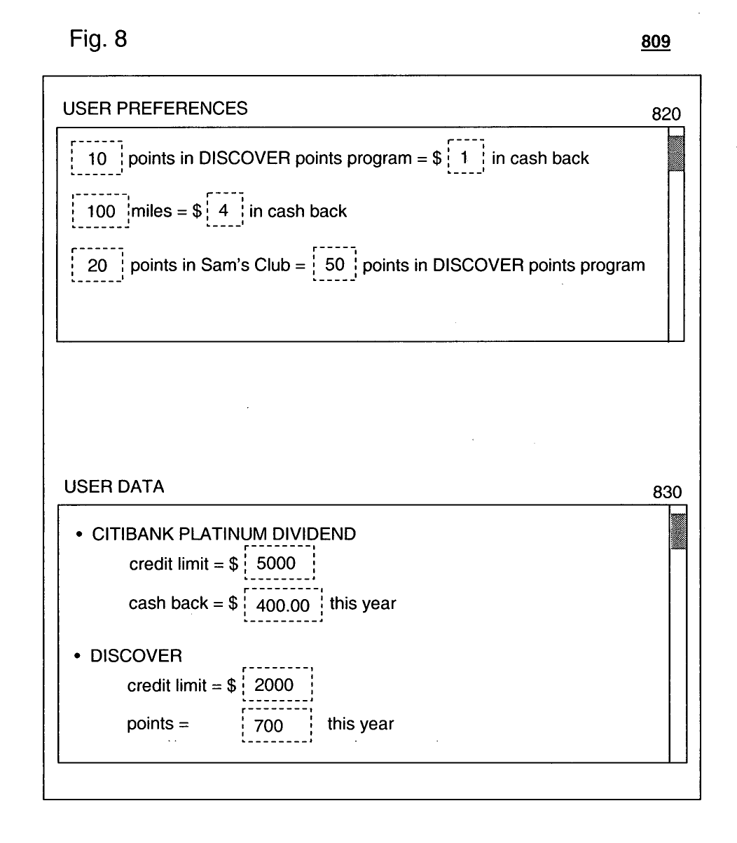

Referring to FIG. 4, in an exemplary embodiment, the user database 412 contains the following information about the user: a) the membership names that the user has specified, b) user data related to different memberships such as how many points the does the user have with a membership, how many miles does the user have, how much cash back the user has already got, what are the spending limits associated with membership, etc., c) user preferences, such as ones shown in subsequent FIG. 8, d) customization information used to customize the interfaces according to user specifications, e) user identification information such as a login and password, f) a user or user-group identifier, especially if such identifiers are used in the membership database records.

Referring to FIG. 4, an exemplary embodiment of user identification module 410 is based on implicit identification in which first the computer on which member selection is carried out is identified. The user identity is then assumed to be identical to the identity of the computer.

Referring to FIG. 4, another exemplary embodiment of user identification module 410 is based on explicit identification method where users are prompted to provide a login and password.

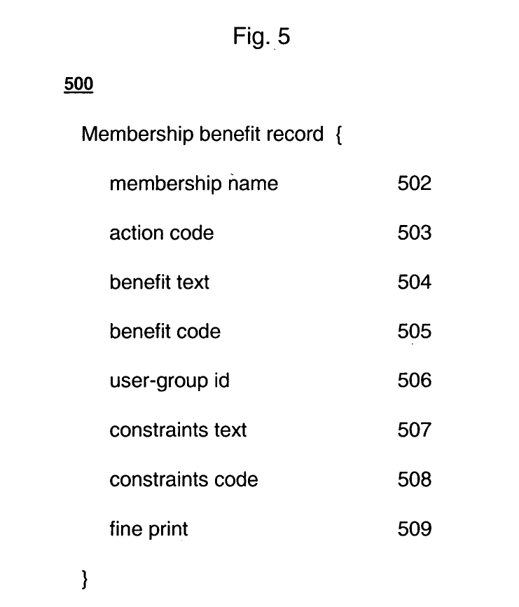

FIG. 5 shows a preferred embodiment 500 of the records contained in the membership database. The membership name field 502 is the name of the membership that this record is about. The action code field 503 is the action, specified as a member of a discrete and finite set of actions described below. The benefit text field 504 is the text representation of the benefit. The benefit code field 505 is the representation of the same benefit as a member of a set of discrete and finite benefits. The benefit code is used by the utility function in the consolidation and sorting module. The user-group ID field 506 is an optional user-group identifier of the user segment to which this database record is application. The constraints text field 507 specifies, as text string, any constraints that are application to the benefits specified in fields 504 and 505. The constraint code field 508 contains the constraints specified as a member of a set of discrete and finite constraints. Similar to the benefit code, the constraint code is also used by the utility function in the consolidation and sorting module described above. The fine print field 509 contains any exclusions and other legal information pertaining to the action and benefit described in this record.

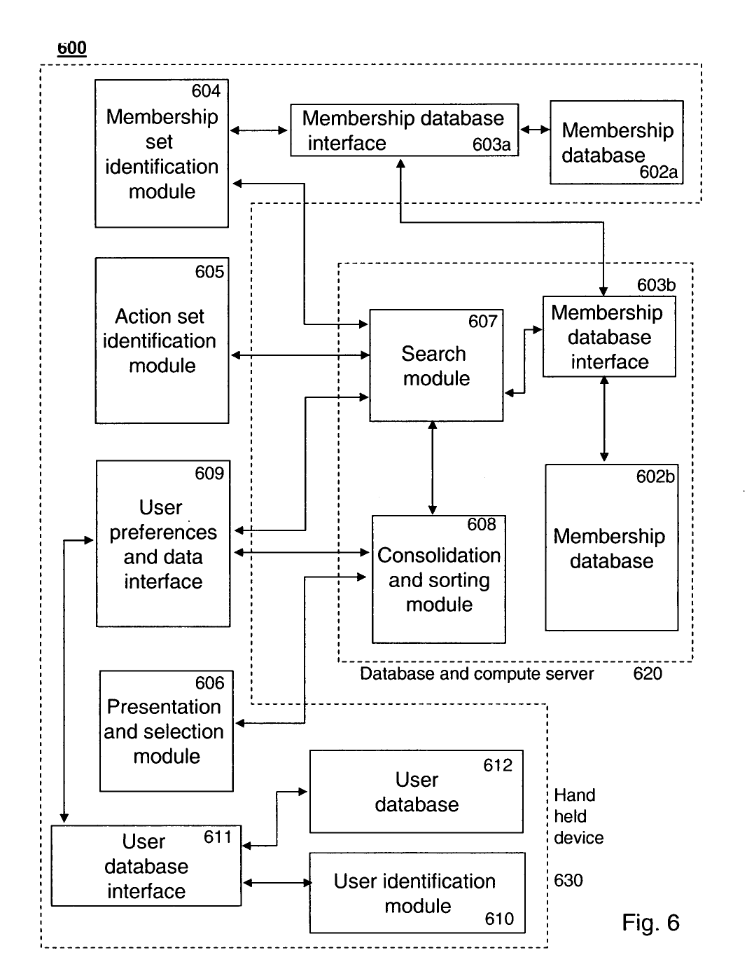

FIG. 6 shows a system 600 according to another exemplary embodiment of the present invention. This embodiment is also based on a hand-held device such as a cellular phone or a personal digital assistant. In this embodiment the search module 607 and the consolidation and sorting module 608 reside on the hand-held device. The user database 616 and user database interface 611 also reside on the hand-held device. Furthermore, the membership database is distributed with one part, 602a residing on the hand-held device and another part 602b residing on the database and compute server 620. The membership database 602a contains records for memberships that the user carries, as given in the user database 612. The membership database 602a on the hand-held device is synchronized with the membership database 602b periodically. In this synchronization process the membership database records pertaining to the user memberships as given in user database 612 are updated into 602a from 602b. Once this update is done, the hand-held device can be used in a stand-alone mode where it does not have to be connected to the internet.

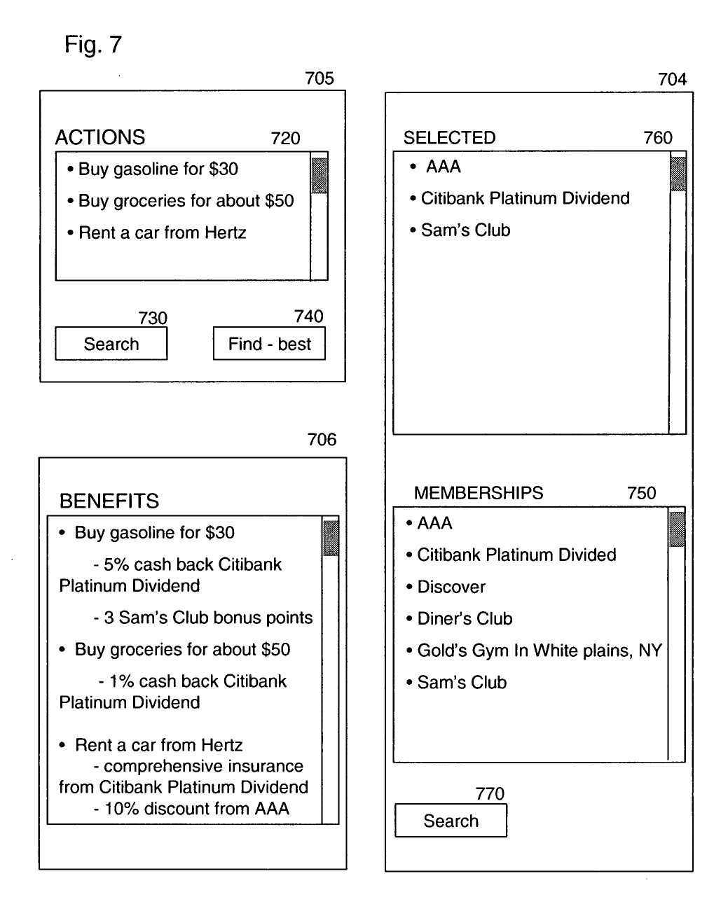

FIG. 7 shows an exemplary embodiment of the membership set identification module 704, the action set identification module 705, and the presentation and selection module 706.

Referring to FIG. 7, the membership set identification module 704 uses the computer screen to present the user with a list of memberships available for selection 750, as well as a list of memberships selected 760. If the user has been identified, the list L of memberships associated with that user could be retrieved from the user databases, and the list of selected memberships 760 could be pre-populated with list L. Any changes made to the list of selected memberships could be stored back to the user database. To navigate the display of membership set identification module 704 for tasks such as selecting or de-selecting memberships, the user may use a selection device such as a computer mouse and keypad. Additionally, voice activated interfaces could be used. Once the user has identified a set of memberships and identified a set of actions, the user can select the search option 770 to direct the membership selection assistant to start the search process.

In another exemplary embodiment of the membership set identification module, the memberships are detected automatically using some remote sensing technology with some device containing membership information. When the user, carrying this device with membership information, goes near a sensor, the membership information is detected by the sensor.

Referring to FIG. 7, in an exemplary embodiment of the action set identification module 705, the user inputs desired actions using an input modality such as a keypad or voice commands. Free form text is entered using the keypad. If the input modality is voice then an automatic voice recognition process is used to convert the voice commands into text. The actions specified by the user are displayed on the computer screen in the display portion 720 of the action set identification module. Once the user has identified a set of actions and identified a set of memberships, she or he can select the search option 730 to direct the membership selection assistant to start the search process. The find-best option 740 in the action set identification module allows the user to see the benefits for all the memberships, not just the ones that the user has specified in the membership set identification module.

In another exemplary embodiment, the action set identification module is based on a display such as the screen of a personal computer or the screen of a hand held device such as a cell phone or a personal digital assistant. On this display the user inputs desired actions by making a selection from a drop down list.

In another exemplary embodiment, the action set identification module is based on some wireless communication mechanism that detects the action as it is carried out by the user. For example, if the user purchases groceries at a grocery store, a device at the store would wirelessly send this information to the hand held device that the user is carrying.

Referring again to FIG. 7, the presentation and selection module 706 displays to the user, separately for each action, the sorted list of consolidated membership benefits. The user is also presented with the option of viewing any fine print information that may be there associated with these benefits. The presentation and selection module 706 could use text-to-speech functionality to speak the sorted benefit information to the user.

In another exemplary embodiment, the presentation and selection module automatically selects, for each action, the top membership from the sorted list and uses that membership to carry out the transactions corresponding to the users specified actions. This selection could be on the basis of, for example, the value of the utility function used in the consolidation and sorting module.

FIG. 8 shows an exemplary embodiment of the user preferences and data interface 809. User preferences are specified in terms of equivalence between different types of benefits. For instance, in the example shown in FIG. 8, the user specifies in the user preferences section 820 that 10 points in DISCOVER points program are equivalent to $1 in cash back, 100 miles are equivalent to $4 in cash back, and 20 points in Sam club are equivalent to 50 points in the DISCOVER points program. These equivalences are used to convert different types of benefits to a common metric so that they can be compared with each other. In the absence of user specified equivalences, some default, user independent, values are used for comparisons. User data such as how many points the does the user have with a membership, how many miles does the user have, how much cash back the user has already got, what are the spending limits associated with membership, etc., are specified in the user data section 830. For specifying data, the user fills in the numbers in the boxes shown by dashed lines in the data section 830. These user preferences and data are stored in the user database together with the user identification information.

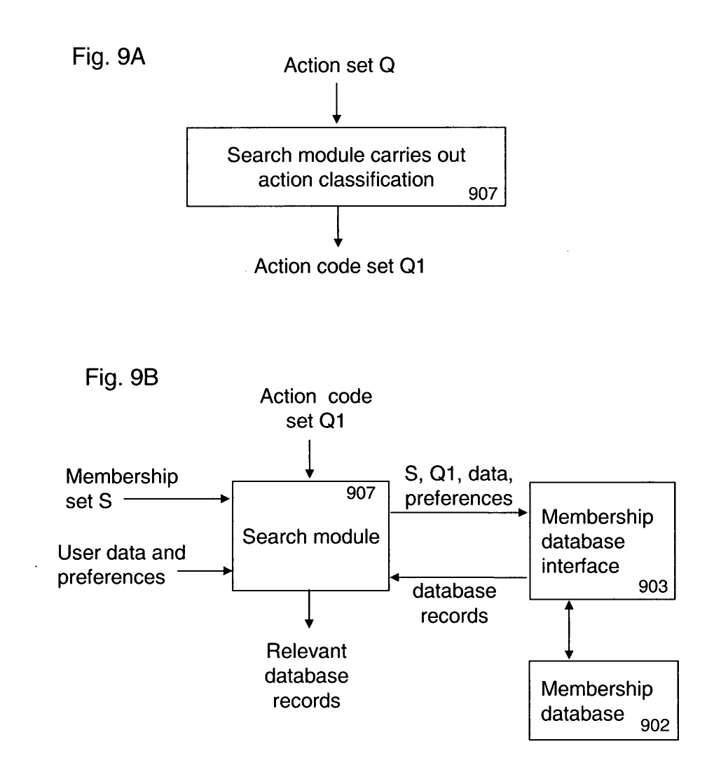

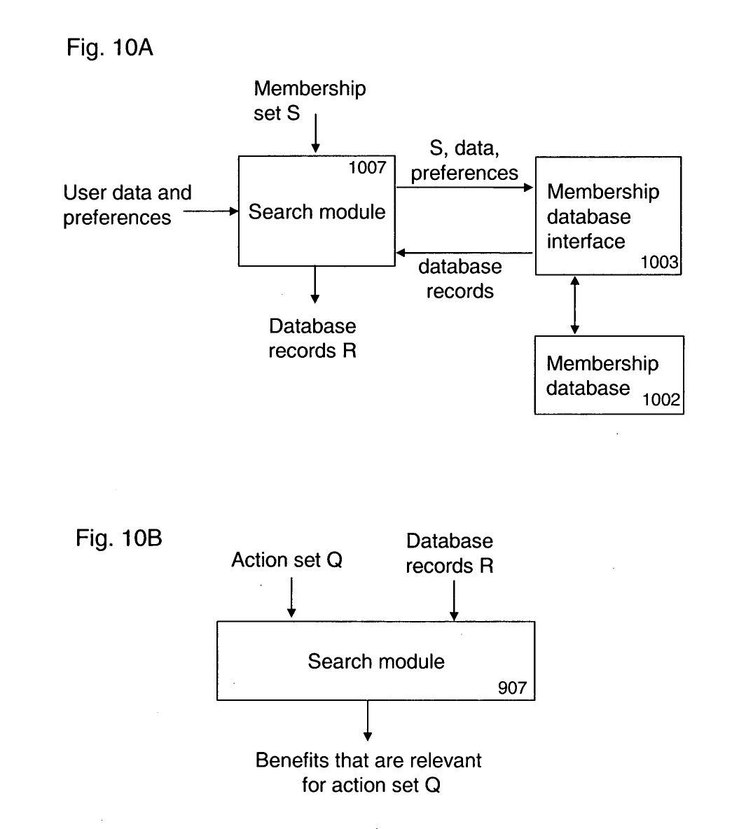

In an exemplary embodiment, the search module carries out the search as depicted in FIG. 9. In this embodiment the user actions are specified as plain text strings, provided in this form by the user or converted to this form from user input in some other form such as voice input. In the first step of the search process, shown in FIG. 9A, each action in set Q is classified into an action-code which is a member of a set of discrete and finite actions. The classification of actions into action-code can be carried out, for example, using algorithms referenced in Thorsten Joachims, text categorization with support vector machines: learning with many relevant features, LS-8 report 23, Computer Science Department, University of Dortmund, Germany. This results in an action-code set Q1. Then, in the second step shown in FIG. 10B, for each membership in the membership set S all the database records whose action code field match any one of the action-codes in set Q1 is retrieved.

Another exemplary embodiment of the search process is shown in FIG. 10. In this embodiment, similar to the embodiment of FIG. 9, the user actions are specified as plain text strings, provided in this form by the user or converted to this form from user input in some other form such as voice input. In the first step, shown in FIG. 10A, the search module takes the membership set S containing the membership names, provided via the membership set identification module, and queries the database to retrieve all the database records that pertain to the memberships in set S. In the next step, shown in FIG. 10B, a term weighting based search, as referenced in G. Salton and C. Buckley, term-weighting approaches in automatic text retrieval, Information Processing & Management, vol. 24(5), pp. 513 23, 1988, is carried out to find the benefit records that are relevant for the specified actions.

An exemplary embodiment of the consolidation and sorting module assumes that no user data and user preferences are available. Consequently, it incorporates a utility function which is user independent, that is, it does not use any user specific data or user preferences. It has pre-defined consolidation criteria, based on benefit codes and membership information, which allow consolidation of membership database records. Furthermore, it has pre-defined criteria for comparison of consolidated records to rank order the memberships. In this exemplary embodiment, the consolidation and rank ordering is carried out separately for each action provided by the user.

In another exemplary embodiment, the consolidation and sorting module consolidates and rank orders membership database records across both actions and memberships and keeps track of benefit and rank order information for various possible groupings of actions. This allows for further optimization of the benefits. A corresponding exemplary embodiment of the presentation and selection module is such that it presents to the user benefit information that has been consolidated and sorted across both actions and memberships. The presentation and selection module also allows users to combine actions any which ever way they wish, and presents them with benefit information on use of memberships for the action combinations they want.

In another exemplary embodiment, the consolidation and sorting module takes user specific data and preferences into account. For instance, if the user provides user data such as various limits that the user may have for different memberships and amounts of benefits already availed, such user data is used by the utility function of the consolidation and sorting module. Similarly, if a benefit has a constraint code associated with it then that constraint can be evaluated against the user data to check whether that constrain is met or not.

In another exemplary embodiment of the consolidation and sorting module, the utility function is updated by learning from user decisions. For example, if the user chooses to use the second membership in the rank ordered list, this information can be used to update the consolidation and comparison criteria used in the utility function. Average user characteristics could be also be learnt to improve the user independent utility function.

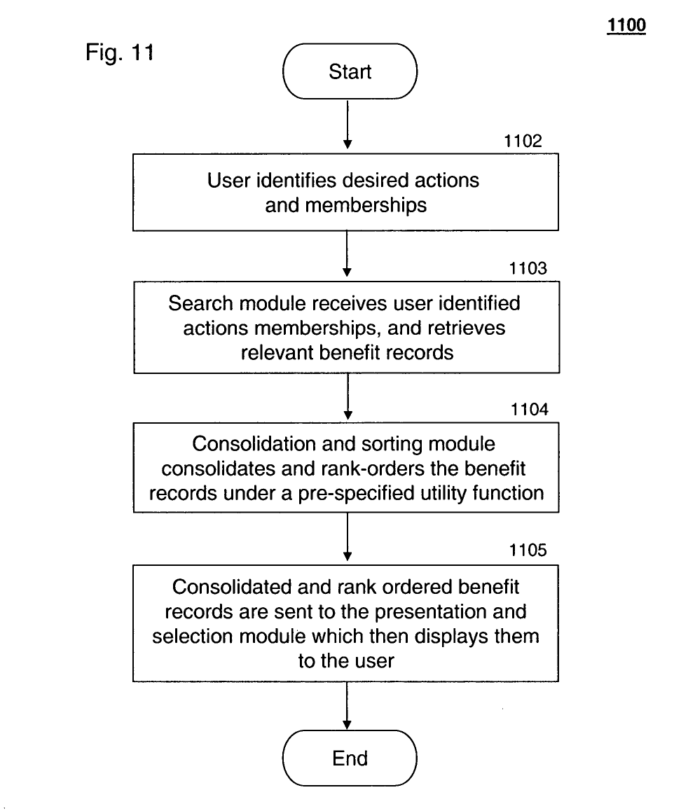

FIG. 11 shows a method in accordance with an exemplary embodiment of the present invention. In the initial step 1102, the user identifies the actions she or he wants to carry out as well as the memberships that she or he wishes to consider for those actions. These user identified actions and memberships are passed on to the search process 1103 which communicates with the membership database via the membership database interface and retrieves relevant benefit records. These benefit records are passed on to the consolidation and sorting process 1104 which uses a pre-specified utility function to consolidate and rank-order the benefit records. The consolidated and rank ordered records are then displayed to the user in the final step 1105.

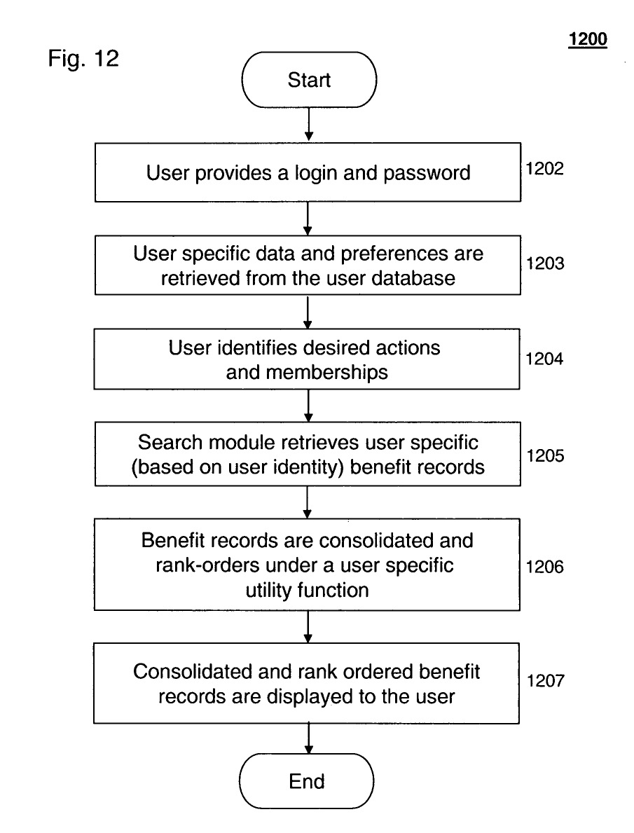

FIG. 12 shows another method in accordance with an exemplary embodiment of the present invention. This method includes user preferences and data as mentioned above. Furthermore, it includes user identification. In the initial step 1202 the user identifies herself or himself by providing user specific identifiers such as a login and password. Once the user is identified the user specific preferences and data are retrieved 1203 from the user database. In the next step 1204 the user identifies the actions she or he wants to carry out as well as the memberships that she or he wishes to consider for those actions. These user identified actions and memberships are passed on to the search process 1205 which communicates with the membership database and retrieves relevant benefit records that are specific to the identified user. These benefit records are passed on to the consolidation and sorting process 1206 which uses a user specific utility function to consolidate and rank-order the benefit records. The consolidated and rank ordered records are then displayed to the user in the final step 1207.

A typical hardware configuration of an information handling/computer system in accordance with the present invention preferably has at least one processor or central processing unit (CPU).

The CPUs are interconnected via a system bus to a random access memory (RAM), read-only memory (ROM), input/output (I/O) adapter (for connecting peripheral devices such as disk units and tape drives to the bus), user interface adapter (for connecting a keyboard, mouse, speaker, microphone, and/or other user interface device to the bus), a communication adapter for connecting an information handling system to a data processing network, the Internet, an Intranet, a personal area network (PAN), etc., and a display adapter for connecting the bus to a display device and/or printer (e.g., a digital printer or the like).

In addition to the system and method described above, a different aspect of the invention includes a computer-implemented method for performing the above method. As an example, this method may be implemented in a computer system environment.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU and hardware above, to perform the method of the invention.

This signal-bearing media may include, for example, a RAM contained within the CPU, as represented by the fast-access storage for example. Alternatively, the instructions may be contained in another signal-bearing media, such as a magnetic data storage diskette, directly or indirectly accessible by the CPU. Whether contained in the diskette, the computer/CPU, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code.

While the invention has been described in terms of several exemplary embodiments, those skilled in the art will recognize that the invention can be practiced with modification within the spirit and scope of the appended claims.

Further, it is noted that, Applicants' intent is to encompass equivalents of all claim elements, even if amended later during prosecution.

What is claimed is:

1. A method of selecting one or more memberships to use for a set of actions that involve use of memberships, said method comprising the steps of
identification of a set of memberships from which said selection will be made; and
identification of a set of actions for which said selection is to be made; and
retrieval from a database of benefits associated with use of said memberships to carry out said actions; and
consolidation and ordering of said retrieved benefits; and
selection of memeberships using said consolidated and ordered benefit information.

2. The method of claim 1, wherein said membership set identification comprises requiring user to specify the set by entering memberships on a data entry device or selecting from a list of memberships.

3. The method of claim 1, wherein said specification is carried out on a computer using a keyboard or voice commands that are converted to text using an automatic voice recognition system.

4. The method of claim 1, wherein said specification is carried out on a hand held device using a keypad, stylus, or voice commands that are converted to text using an automatic voice recognition system.

5. The method of claim 1, wherein said membership set identification comprises using a remote sensing mechanism to detect the memberships that the user is carrying.

6. The method of claim 5, wherein said remote sensing is carried out using RF ID.

7. The method of claim 1, wherein said action set identification comprises requiring user to specify the set by entering actions on a data entry device or selecting from a list of actions.

8. The method of claim 7, wherein said specification is carried out on a computer using a keyboard or voice commands that are converted to text using an automatic voice recognition system.

9. The method of claim 7, wherein said specification is carried out on a hand held device using a keypad, stylus, or voice commands that are converted to text using an automatic voice recognition system.

10. The method of claim 1, wherein said action set identification comprises automatic identification on the basis of physical actions of the user.

11. The method of claim 1, wherein said consolidation and ordering of said retrieved benefits is carried out using a set of pre-defined rules.

12. The method of claim 1, wherein said selection of memberships comprises presenting said consolidated and sorted benefit information to the user and letting user make the selection.

13. The method of claim 1, wherein said selection of memberships is automatically carried out on the basis of said consolidated and sorted benefit information so as to optimize a pre-specified utility function.

14. The method of claim 1, further incorporating user specific preferences and data, and comprising the steps of
customization of said benefit retrieval step to retrieve user specific benefits; and
customization of said consolidation and ordering step to carry out consolidation and sorting utilizing user preferences, in a manner that is optimal for the user; and
customization of said selection step to carry out selection that is optimal for the user.

15. The method of claim 14, wherein said user specific preferences and data are updated on the basis of user specific information that is collected when users utilize said membership selection.

16. An article of manufacture for developing a membership selection system, comprising a computer readable medium containing one or more programs which when executed implement the steps of:
identification of a set of memberships from which membership selection will be made; and
identification of a set of actions for which said selection is to be made; and
retrieval from a database of benefits associated with use of said memberships to carry out said actions; and
consolidation and ordering of said retrieved benefits; and
selection of memeberships using said consolidated and ordered benefit information.

17. The article of manufacture of claim 16, further incorporating storage of user specific preferences and data, and comprising the steps of
customization of said benefit retrieval step to retrieve user specific benefits; and
customization of said consolidation and ordering step to carry out consolidation and sorting utilizing user preferences, in a manner that is optimal for the user; and
customization of said selection step to carry out selection that is optimal for the user.

18. The article of manufacture of claim 17, further including storage of user identity that can be used to retrieve said user preferences and data.
